(19) United States
(12) Patent Application Publication
(10) Pub. No.: US 2007/0012036 A1
(43) Pub. Date: Jan. 18, 2007

(54) Rotating accessory for motor vehicle tail pipe

(76) Inventor: Corey Perry, Stroudsburg, PA (US)

Correspondence Address: Kenneth P. Glynn, 24 Mine Street, Flemington, NJ, 08822, US

(21) Appl. No.: 11/183,492

(22) Filed: Jul. 18, 2005

(51) Int. Cl. F02B 35/00

(52) U.S. Cl. 60/316

(57) ABSTRACT

A motor vehicle having an internal combustion motor and a wheel drive mechanism, wherein the motor has an exhaust system connected thereto, includes a) an exhaust system having an exhaust pipe and a rotating accessory, with the exhaust pipe being in a fixed position relative to the internal combustion motor, and the accessory being rotatably connected to the exhaust pipe, and b) an accessory drive mechanism connected to the accessory for rotation of the accessory. The accessory drive mechanism may operate off some power source of the vehicle, operate independently of the vehicle power sources, may operate from exiting exhaust gases, ambient wind form motion of the vehicle, or a combination of the foregoing.

### BACKGROUND OF THE INVENTION

1. Field of the Invention

The present invention relates to a combined functional and decorative exhaust system for motor vehicles. The term “motor vehicle” as used herein means a motorized vehicle having at least two wheels thereon. Hence, it includes motorcycles, scooters, motorized bikes, three wheel minicars, three wheel trucks, three wheel open air vehicles, such as ATVs and motorized trikes, as well as more common motor vehicles, such as autos, trucks, buses, tractors, semis, SUVs, and the like. It is particularly applicable to motor vehicles with exhaust pipes, especially internal combustion driven motor vehicles, but could also be used with motor vehicles having simulated or nonfunctional pipes. More particularly, the present invention relates to a rotating accessory that is rotatably attached to a motor vehicle exhaust pipe that may add dynamic and artistic appearance (and may or may not act as a hot exhaust gas dissipater). It may also serve as an eye-catching safety feature that will, in some instances, make other drivers more readily aware of the presence of vehicle having the present invention. Thus, the present invention includes a fixed exhaust pipe and at least one rotating accessory rotatably connected to the pipe, and at least one drive mechanism to rotate the accessory or accessories. The term “exhaust pipe” and the term “tail pipe” may be considered different by some technicians, but are used herein interchangeably because, for purposes of this invention, any technical differences between the two are irrelevant.

2. Information Disclosure Statement

The following patents are representative of prior art of interest to the present invention technology:

U.S. Pat. No. 5,579,638 describes an adjustable exhaust system for use with two cycle motors. An insert section of pipe is interposed between a header pipe and a conventional tail pipe so that, when it is rotated, the overall length of the exhaust system is adjusted. The insert section is held in place between the tail pipe and a header extension pipe by a compressive force exerted by one or more springs attached between the header and the tail pipe. The insert features, on an end that slips over the header extension section, a series of graduated notches which mate with a protrusion, or “stop”, formed on the mating end of a header extension section. This notch and stop combination determines the distance by which the insert section will be permitted to slip over the header extension section, and correspondingly, the overall length of the exhaust system.

U.S. Pat. No. 5,058,704 describes an improved muffler including a body with an exhaust inlet in the form of a porous pipe enclosed in a second porous pipe for diffusing exhaust gases into the interior of body. A pair of pipes introduces ambient air into the discharge region of the muffler. A constricted discharge opening of the body encircles the pipes and confines the helical vanes which impart a helical path to the exhaust gases just before mixing with ambient air from the pipes. A venture section with a bell shape outlet completes the tail pipe section. An auxiliary air inlet to the venture adds additional ambient air to the final outlet via ports. In addition embodiment, the venture section is within the muffler body. A constricted tube provides a direct path for a portion of the exhaust gases while the major quantity of exhaust gases traverse the helical paths defined by the vanes.

U.S. Pat. No. 5,058,703 describes an exhaust to reduce noise, an automotive exhaust tailpipe that has a convoluted surface at or near its outlet to generate pairs of counterrotating axial vortices within the exhaust gases just before or just after the gases exit the tailpipe. The convoluted surface of the tailpipe, or a thin-walled convoluted member, may be disposed within the tailpipe near its outlet end.

U.S. Pat. No. 4,860,538 describes several embodiments of motorcycle exhaust systems having forward and rearward exhaust pipes at least one of which extends transversely in a transversely extending expansion chamber for improving high speed performance. In addition, a variety of control valves are incorporated for varying the reflective area of the exhaust pipe ends so as to improve low speed and midrange performance.

U.S. Pat. No. 4,220,219 describes a lightweight muffler and method for muffling a noise component of a stream of gases. The muffler includes a chamber in which gases are directed side-by-side streams flowing in opposite directions. The streams are in contact with each other for the generation of sound dampening eddy currents in the chamber, but such contact does not break down the continuous, low resistance flow of gases through the muffler. The chamber is advantageously formed as a expansion chamber in which gases: enter one end of the chamber as an annular stream concentric with the inlet pipe to the muffler, travel along the inlet pipe to the other end of the chamber, are reversed, and travel as a concentric annular stream of greater diameter in the opposite direction down the length of the chamber for discharge into a passageway leading to the outlet tube to the muffler. A second similarly formed chamber for counterflow of opposed streams and the generation of eddy current there between is preferably formed proximate the outlet tube of the muffler.

Notwithstanding the prior art, the present invention is neither taught nor rendered obvious thereby.

### SUMMARY OF THE INVENTION

The present invention relates to a combined functional and decorative exhaust system for internal combustion driven motor vehicles that includes a fixed exhaust pipe and a rotating exhaust pipe accessory rotatably connected to the pipe. The present invention is an improvement to motor vehicles that provides dynamic and artistic aspects, in some cases acts as a hot exhaust gas heat dissipater, noxious gas dilution mechanism and/or an eye-catching safety feature. Thus, the present invention is an improvement in a motor vehicle having an internal combustion motor and a wheel drive mechanism, wherein the motor has an exhaust system connected thereto.

It includes a) an exhaust system having an exhaust pipe and at least one exhaust pipe accessory, with the exhaust pipe being in a fixed position relative to the internal combustion motor, and the at least one accessory being rotatably connected to the exhaust pipe, and b) an accessory drive mechanism connected to the accessory to rotate it. The accessory or accessories may be located at the actual end of the pipe, at the beginning of the pipe or at any intermediate section of pipe. For example, in the case of the semi or other truck or vehicle having vertical or diagonal pipes, or vehicles having externally exposed horizontal pipes, a midsection thereof could include one or more rotating accessories. Alternatively, one or more could be attached at the top (end) or they could be evenly or unevenly arranged along the length of the pipe or a portion thereof Likewise, the same possibilities would exist for a motorcycle or other vehicle application of the present invention.

In some embodiments of the present invention device, the improvement further includes an annular connector located between the exhaust pipe and the accessory, the annular connector having disparate portions rotatable with respect to one another and having a plurality of bearings. By “annular” is meant donut shaped, with a hole in the center (located about the first, fixed pipe), or one or more segmented arcs thereof. The bearings may be any rotating bearing arrangement, e.g., arms with individual rollers, but are preferably selected from the group consisting of ball bearings and roller bearings. In some preferred embodiments of the present invention device, there are at least two of these annular connectors, especially when the accessory is more than one half foot or so in length.

The exhaust pipe accessory drive mechanism may be any that will rotate the accessory. These include drives that derive power from anywhere on the motor vehicle, i.e., taking power or driving force from the motor, the main wheel drive, the wheels themselves, the main battery, etc., or it may have its own power source and thus be independent of the power of the motor vehicle itself. These independent power sources may be onboard or derived from ambient air, i.e., wind blowing turbines, especially the ram air wind created when the motor vehicle is moving forward. Thus, the accessory drive mechanism may be a plurality of wind vanes connected to the accessory. These wind vanes may be positioned to be exposed to and driven by exhaust gases, relying on internal combustion exhaust gases for power. Or, these wind vanes may be positioned to be exposed to and driven by ambient (outside) air flow against the plurality of wind vanes. Or, both, that is, these wind vanes may be at least partially positioned to be exposed to and driven by ambient air flow against the plurality of wind vanes, and at least partially positioned to be exposed to and driven by ambient air flow against the plurality of wind vanes.

Alternatively, the present invention accessory drive mechanism may be a mechanically connected take-off from the device wheel drive mechanism, or, it could be a mechanically connected take-off from the motor. For example, the accessory drive mechanism may be a wheel-driven friction drive mechanism, that is, a small friction wheel against a tire or rim that would mechanically power the accessory drive mechanism or would drive a generator to run an electric motor accessory drive. In some embodiments of the present invention device, the accessory drive mechanism is an independent electric motor with its own battery and accessory connecting components.

In some embodiments of the present invention device, the motor vehicle (as with most conventional vehicles) includes a conventional main battery for starting and operating electric components, and the accessory drive mechanism is an electric motor with accessory-to-pipe connecting components, the electric motor being connected to the main battery.

In some preferred embodiments of the present invention device, the improvement further includes at least one visual enhancement to the accessory. The visual enhancement may be any decoration, paint, decal, emblem, symbol, or other feature, such as fins, rhinestones, studs, flutes, grills, etc. In some embodiments of the present invention, the enhancement may be selected from the group consisting of cut-outs, embossments, outshoots, add-ons and topographical variations. Cut-outs are basically holes; embossments are stamped or pressed indentations; outshoots are reverse embossments; add-ons are additional parts, like fins, that may be welded, riveted, bolted or otherwise attached; topographical variations are surface changes, such as polished and brushed metal sections, grooves, cross-hatchings, etches, etc.

In some embodiments of the present invention device, the visual enhancement is lighting on the second exhaust pipe that rotates with the accessory. In other embodiments, the visual enhancement is a combination of at least one cut-out and at least one fixed backlight aligned with the cut-out(s) to create a strobe effect when the backlight is on and the accessory is rotating.

In many embodiments of the present invention device, there are at least two separate accessories that rotate. These two separate accessories may be drive-connected and rotate synchronically with one another or they may be independent of one another.

In some embodiments of the present invention, the accessory may further include an outer housing that may be fixed. For example, an outer fixed ring with rotating blades may simulate a jet turbo prop or engine.

### BRIEF DESCRIPTION OF THE DRAWINGS

The present invention should be more fully understood when the specification herein is taken in conjunction with the drawings appended hereto wherein:

FIG. 1 illustrates a side perspective view of a present invention motorcycle with a rotating tailpipe accessory having a plurality of ribboned bars that rotate;

FIGS. 2, 3 and 4 shown side views of details of the present invention rotating accessory of FIG. 1;

FIGS. 5 and 6 show back and side views of another present invention motor vehicle with rotating accessories;

FIGS. 7, 8 and 9 show side views of details of the present invention rotating accessories of FIGS. 5 and 6;

FIGS. 10 and 11 show a partial cut view and detailed partial cut view of a present invention accessory device on an automobile exhaust pipe;

FIGS. 12 and 13 show a side view and detailed top view of a present invention accessory device on a semi truck; and,

FIG. 14 shows alternative embodiment present invention rotating tailpipe accessory drive mechanisms in addition to those described in conjunction with the above Figures.

### DETAILED DESCRIPTION OF THE PRESENT INVENTION

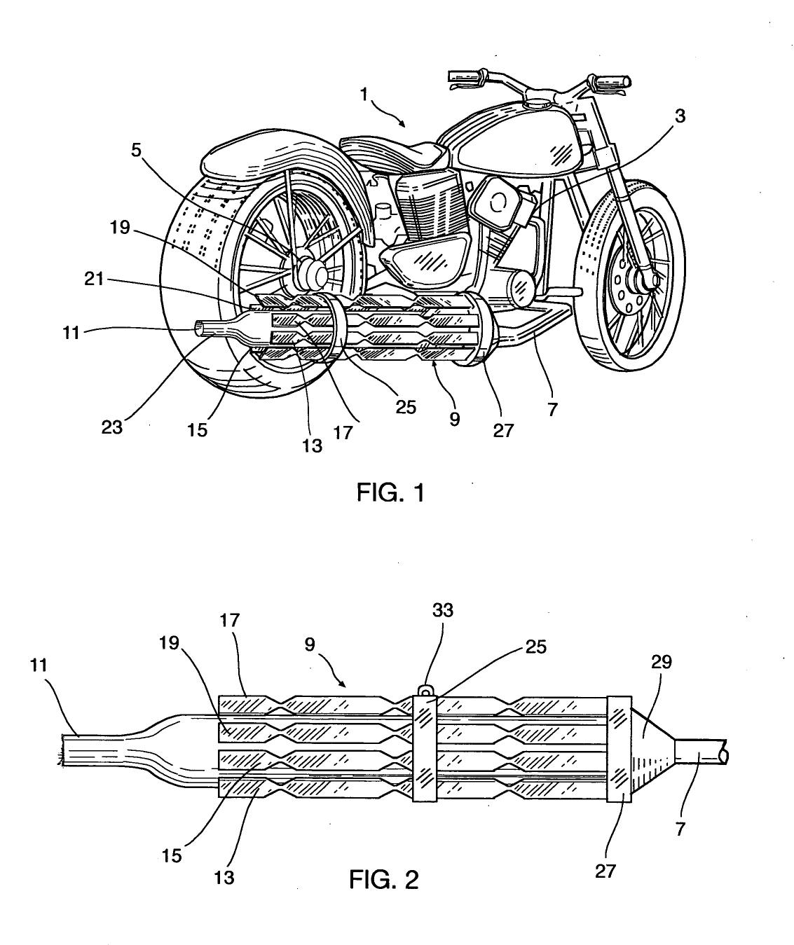

FIG. 1 illustrates a side view of a present invention motorcycle 1 having an internal combustion engine motor 3, a rear wheel drive mechanism 5 (could be chain, belt, gear, shaft or any available mechanism), and an exhaust pipe 7 that is fixed relative to motor 3. There is a rotating exhaust pipe accessory 9 having a plurality of ribboned flat bars 13, 15, 17, 19, 21 and 23 similar to a rotary turret. In this case, the exhaust pipe 7 has a rearward smaller cross-section piece 11 that extends beyond accessory 9. There is a two piece annular connector 25 with a stationary outside and a rotating inside with bearings therebetween. The outside is fixed to the vehicle and the inside is fixed to the rotating accessory 9. There is an accessory drive mechanism 27, discussed in further detail below.

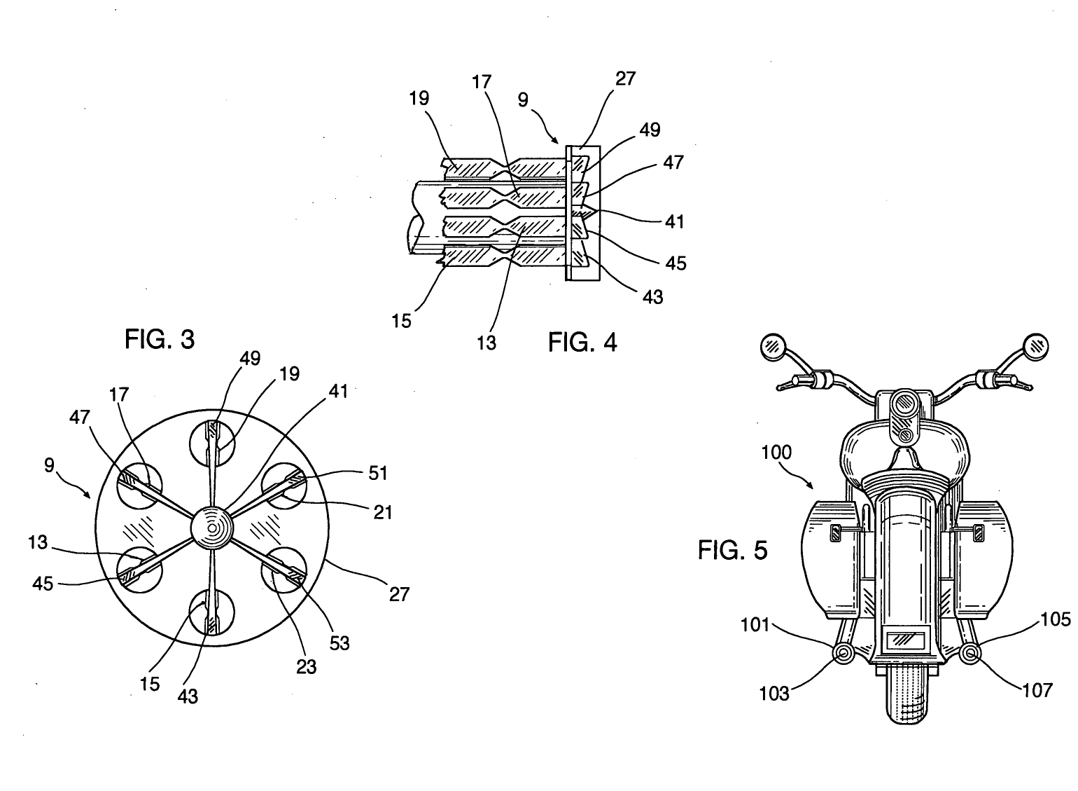

FIGS. 2, 3 and 4 show side, end and side views of details of the present invention rotating exhaust pipe accessory 9 of FIG. 1. In FIG. 2, identical parts from FIG. 1 are repeated and identically numbered. Also, FIG. 2 shows the exhaust gas expansion cone 29 (substantially hidden in FIG. 1) and the relative positions of the accessory drive mechanism 27 and the annular connector 25 with attachment bracket 33. FIG. 3 and FIG. 4 show side and front views of the internal features of the pipe drive mechanism 27. As can be seen in these Figures, there are turbine blades (wind vanes) 43, 45, 47, 49, 51 and 53 located over the concentric orifices and a flow-spreading cone 41 to aid in exhaust gas distribution. When the exhaust gases hit the turbine blades, the entire turret-like exhaust pipe accessory 9 rotates. In this embodiment, the speed of rotation is directly related to the thrust of the engine exhaust. Revving the engine increases the spin of the accessory.

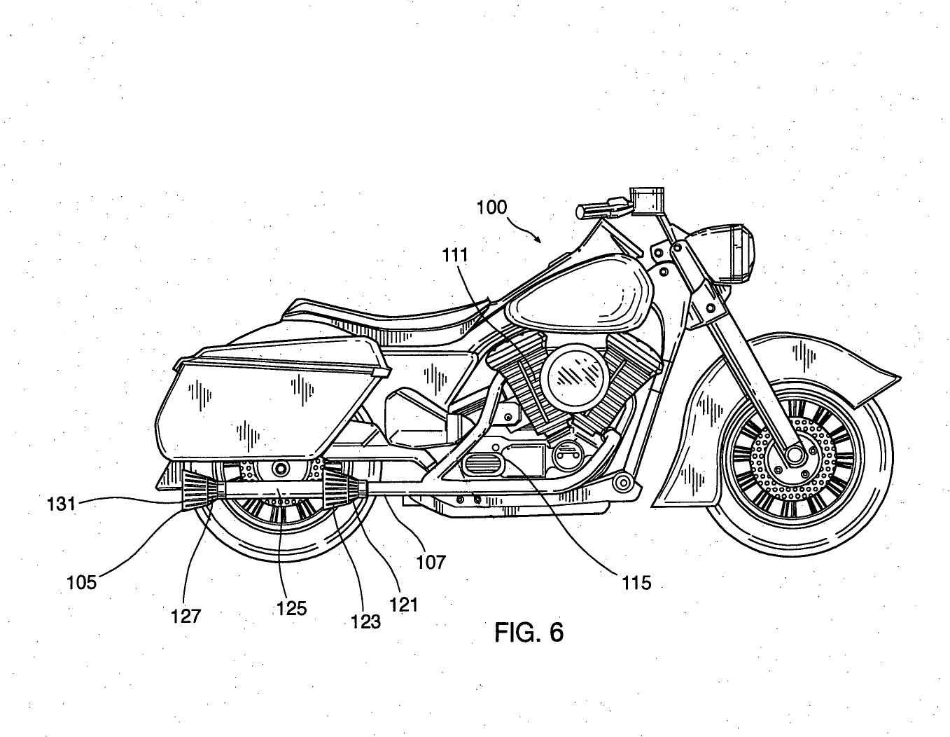

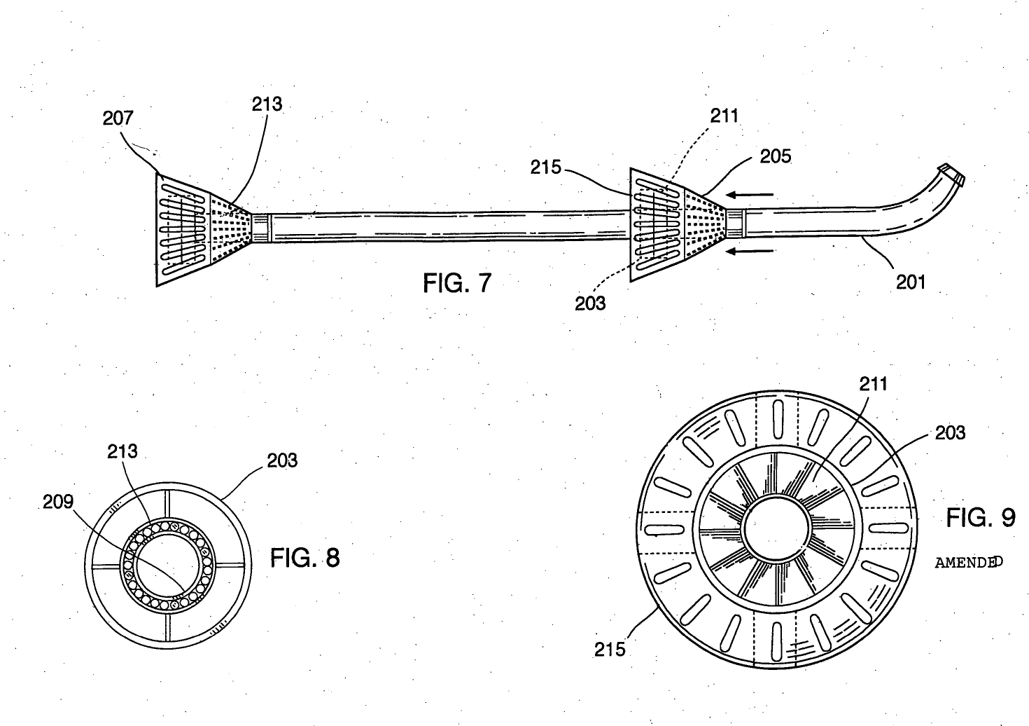

FIGS. 5 and 6 show rear and side views of another present invention motorcycle 100 with a rotating tailpipe accessories 101 and 105 shown simplistically as outer circles. Exhaust pipes 103 and 107 are stationary with respect to motor 111 and wheel drive mechanism 115. The right side rotating accessories 105 and 123 are spaced in front and in back of pipe midsection 125, and are cones that have enhancements in the form of flutes or cut-outs, such as cut-out 131. These enhancements in the Figure could alternatively be studs, embossments, lights, cut-outs with backlighting, or any other discussed above. The accessories 105 and 123 rotate and are driven by the air rams caused by the forward or reverse motion of the vehicle as that air passes through fixed open grills 121 and 127, identical in function to that described below with respect to FIGS. 7 through 9 below.

FIGS. 7, 8 and 9 shown side, end and side views of details of the present invention rotating tailpipe accessories of the type shown in FIGS. 5 and 6. Exhaust pipe 201 is a fixed pipe attached to an internal combustion motor (not shown). Accessories 207 and 215 are rotatably attached to pipe 201 with bearing-containing annular connectors, such connector 203. In front of accessories 207 and 215 are fixed open grills 205 and 213 for external air to enter the accessory drive mechanisms, such as turbine blades 211 (detailed in FIG. 9). When the vehicle is driven forward, air rams into the grill 205 and spins blades 211 and thus spins accessory 215. The speed of the spinning accessories is dependent on the rate of air ramming the vanes, and independent of the speed or RPM's of the motor.

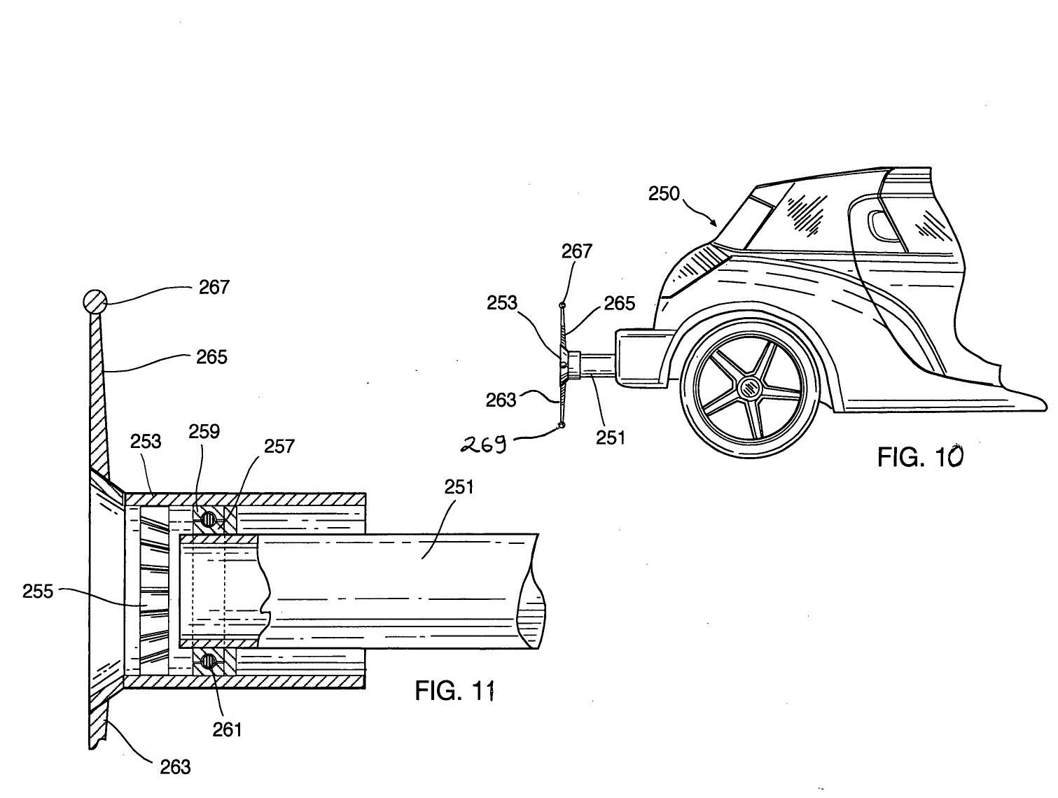

FIG. 10 shows a partial cut view a present invention device on automobile 250 at its rear bumper area, and FIG. 11 shows a detailed partial cut view of the device. Here, fixed, conventional straight exhaust pipe 251 extends behind the rear of automobile 250. Attached to pipe 251 is an inner ring 257 of an annular connector, its outer ring 261 being attached to the inside of the rotatable accessory 253. Fitted between the inner ring 257 and the outer ring 259 are a plurality of ball bearings, such as bearing 261. This enables accessory 253 to freely spin about exhaust pipe 251. Because accessory 253 has a turbine drive mechanism 255, when exhaust gases pass therethrough, the pipe 253 spins. Enhancements to accessory 253 include a plurality of radial members, such as spokes 263 and 265, terminating with spheres, such as spheres 267 and 269. These spheres could include battery operated lights, if desired.

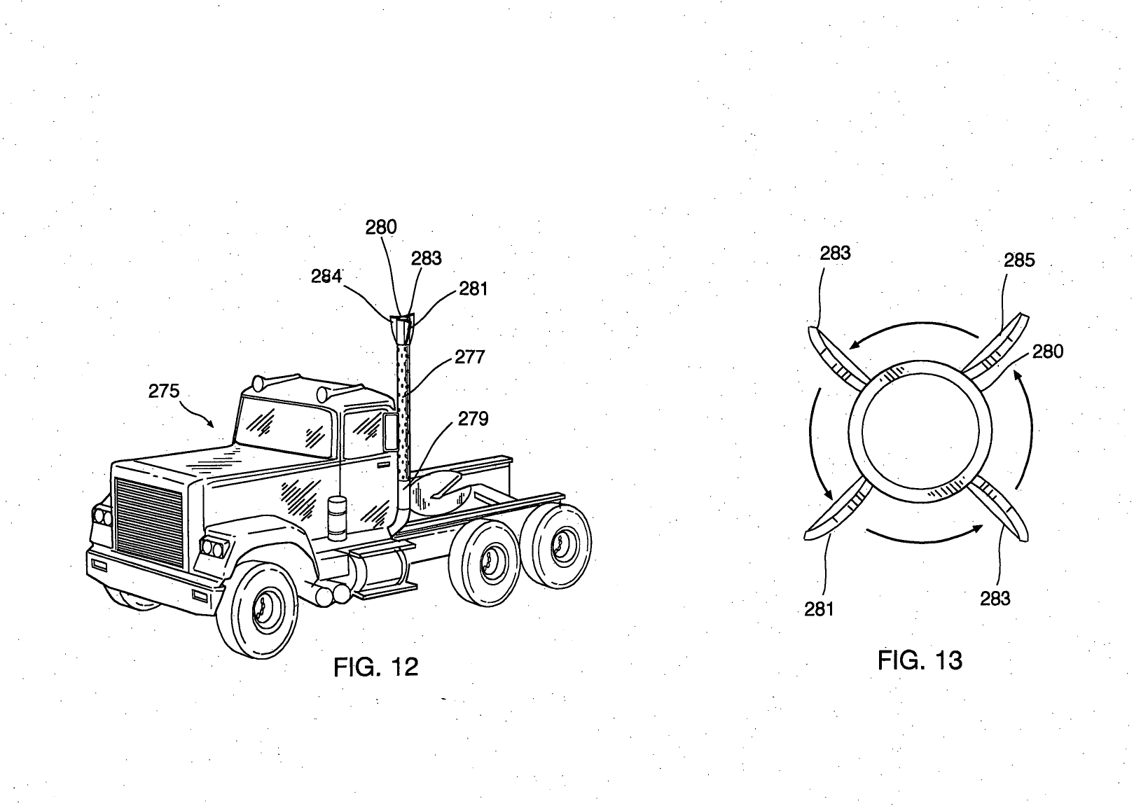

FIG. 12 shows an oblique view of semi truck 275 and present invention spinning vertical exhaust pipe accessory 280, and FIG. 13 shows a detailed top view of the present invention accessory 280. As shown in FIG. 13, the driving mechanism is a set of wind vanes with cups 281, 283, 284 and 287. The spinning accessory 280 is rotatably nested on pipe shield 277, which surrounds pipe 279. It is driven by the air rammed caused by forward motion of the semi truck 275.

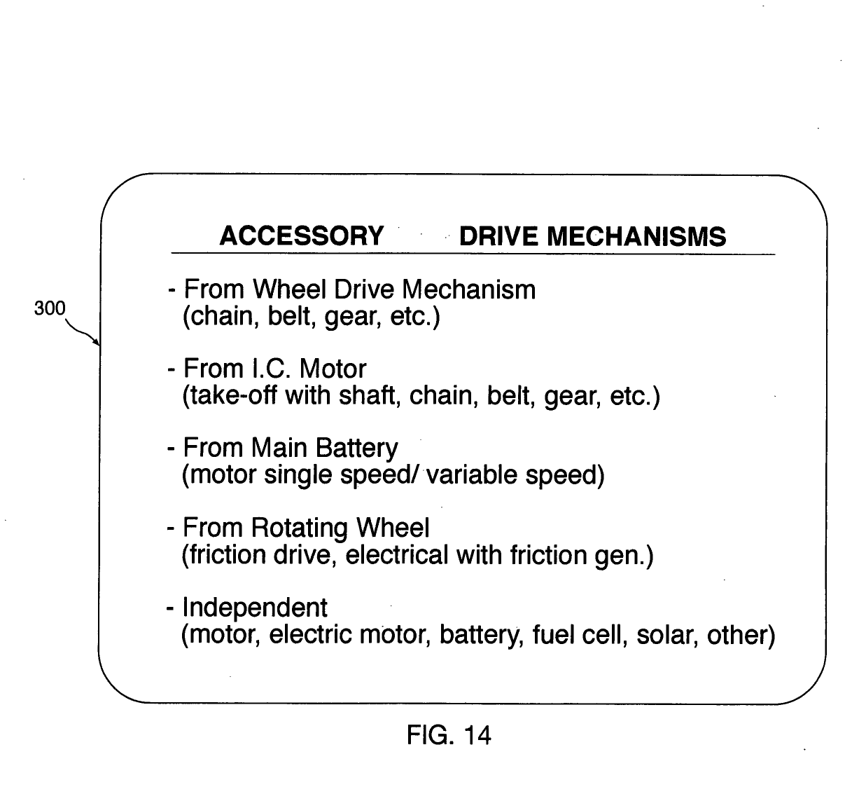

FIG. 14 shows alternative embodiment present invention rotating tailpipe accessory drive mechanisms in chart 300. These include many discussed above as well as some additional alternative arrangements.

Obviously, numerous modifications and variations of the present invention are possible in light of the above teachings. For example, the present invention devices may involve any type of exhaust pipe arrangement, including a single pipe, a set of two or more single pipes from separate exhaust lines, a plurality of single or multiple pipes manifolded from one or more than one main pipe, or any other possible pipe arrangement. The devices may be for all, some or only one of a plurality of pipes on the vehicle. Further, although the devices of the present invention are shown as based on linear or straight line flow of exhaust gases and/or ambient air flow, diverters and/or manifolds could be used to change or even reverse flow direction to move the rotating second pipes, without exceeding the scope of the present invention. It is therefore understood that within the scope of the appended claims, the invention may be practiced otherwise than as specifically described herein.

1-40. (canceled)

41. In a motor vehicle having an internal combustion motor and a wheel drive mechanism, said motor having an exhaust system connected thereto, the improvement which consists of:
a) said exhaust system having an exhaust pipe and at least one rotating accessory, said exhaust pipe being in a fixed position relative to said internal combustion motor, said accessory being rotatably connected to said exhaust pipe and located on said exhaust pipe so as to freely spin about said exhaust pipe when operating to add dynamic and artistic appearance to said motor vehicle; and,
b) an accessory drive mechanism different from said accessory, located in a position selected from the group consisting of a) inside said exhaust pipe, b) on said exhaust pipe on the outside of said exhaust pipe, c) adjacent a wheel, and d) connected to a motor drive mechanism, said accessory drive mechanism being connected to said rotating accessory for rotation thereof.

42. In the device of claim 41, the improvement which includes an annular connector located between said exhaust pipe and at least one of said at least one rotating accessory, said annular connector having disparate portions rotatable with respect to one another and having a plurality of bearings located therebetween wherein at least one of said disparate portions is attached to said tailpipe and at least one other of said disparate portions is ratable relative to said tailpipe.

43. In the device of claim 42, the improvement wherein said bearings are selected from the group consisting of ball bearings and roller bearings.

44. In the device of claim 42, the improvement which includes at least two of said annular connectors.

45. In the device of claim 41, the improvement wherein said accessory drive mechanism is a plurality of wind vanes.

46. In the device of claim 41, the improvement wherein said at least one accessory drive mechanism being exposed to and are driven by exhaust gases passing through said exhaust pipe.

47. In the device of claim 45, the improvement wherein said wind vanes are positioned to be exposed to and are driven by ambient air flow against said plurality of wind vanes.

48. In the device of claim 41, the improvement which includes at least one visual enhancement to said accessory that is selected from the group consisting of cut-outs, embossments, outshoots, add-ons and topographical variations.

49. In the device of claim 48, the improvement wherein said visual enhancement is lighting on said at least one accessory that rotates with said at least one accessory.

50. In the device of claim 48, the improvement wherein said visual enhancement is a combination of at least one cut-out and at least one fixed backlight aligned with said at least one cut-out to create a strobe effect when said backlight is on and said at least one accessory is rotating.

51. In the device of claim 41, the improvement wherein there are at least two separate accessories that rotate independently of one another.

52. In the device of claim 51, the improvement wherein there are at least two separate accessories that are drive-connected and rotate synchronically with one another.

53. In the device of claim 21, the improvement wherein at least one of said rotating accessory and said accessory drive mechanism has an external housing connected to said exhaust pipe.

54. In the device of claim 53, the improvement wherein said rotating accessory includes a fixed outer housing connected to said exhaust pipe.
